(19) United States
(12) Patent Application Publication
(10) Pub. No.: US 2023/0062890 A1
(43) Pub. Date: Mar. 2, 2023

(54) METHOD, APPARATUS, AND SYSTEM FOR MAINTAINING MAP ACCURACY

(71) Applicant: HERE Global B.V., Eindhoven (NL)

(72) Inventor: Jan VAN SICKLE, Denver, CO (US)

(21) Appl. No.: 17/410,720

(22) Filed: Aug. 24, 2021

(51) Int. Cl. G01C 21/00; B60W 60/00

(52) U.S. Cl. CPC G01C 21/3822; B60W 60/001; G01C 21/387; G01C 21/3826; G01C 21/3867

(57) ABSTRACT

An approach is provided for maintaining map accuracy considering tectonic plate movements. The approach, for example, involves processing data to determine a tectonic plate on which a map feature of a geographic database is located. A stored position of the map feature is associated with a time epoch assigned to the stored position. The approach also involves determining a velocity of a movement of the tectonic plate. The approach further involves monitoring an estimated position of the map feature over time based on the stored position and the velocity of the movement of the tectonic plate. The approach further involves automatically flagging or updating the stored position of the map feature based on determining that the estimated position differs from the stored position by more than a distance threshold.

### BACKGROUND

Modern location-based services and applications (e.g., autonomous driving) are increasingly demanding highly accurate and detailed digital map data. Map accuracy inevitably deteriorates with time due to the tectonic plate movements of the Earth. When the scope is global and the absolute accuracy requirements are stringent, the map data will move away from those requirements inconsistently unless a maintenance strategy is implemented. Points, lines and polygons move at different rates and in different directions. However, the position movements of these points, lines, and polygons with the tectonic plates are not factored in the map database. Due to such deficiencies, the resulting map data have errors that can be greater than what is needed for demanding applications such as but not limited to autonomous driving. Accordingly, map service providers face significant technical challenges with respect to maintaining map accuracy needed for these applications.

### SOME EXAMPLE EMBODIMENTS

Therefore, there is a need for an approach for maintaining map accuracy (e.g., with an absolute error of less than 1 meter) considering tectonic plate movements.

According to one embodiment, a method comprises processing data to determine a tectonic plate on which a map feature of a geographic database is located. A stored position of the map feature is associated with a time epoch assigned to the stored position is . The method also comprises determining a velocity of a movement of the tectonic plate. The method further comprises monitoring an estimated position of the map feature over time based on the stored position and the velocity of the movement of the tectonic plate. The method further comprises automatically flagging or updating the stored position of the map feature based on determining that the estimated position differs from the stored position by more than a distance threshold.

According to another embodiment, an apparatus comprises at least one processor, and at least one memory including computer program code for one or more computer programs, the at least one memory and the computer program code configured to, with the at least one processor, cause, at least in part, the apparatus to process data to determine a tectonic plate on which a map feature of a geographic database is located. A stored position of the map feature is associated with a time epoch assigned to the stored position. The apparatus is also caused to determine a velocity of a movement of the tectonic plate. The apparatus is further caused to monitor an estimated position of the map feature over time based on the stored position and the velocity of the movement of the tectonic plate. The apparatus is further caused to automatically flag or update the stored position of the map feature based on determining that the estimated position differs from the stored position by more than a distance threshold.

According to another embodiment, a non-transitory computer-readable storage medium carries one or more sequences of one or more instructions which, when executed by one or more processors, cause, at least in part, an apparatus to process data to determine a tectonic plate on which a map feature of a geographic database is located. A stored position of the map feature is associated with a time epoch assigned to the stored position. The apparatus is also caused to determine a velocity of a movement of the tectonic plate. The apparatus is further caused to monitor an estimated position of the map feature over time based on the stored position and the velocity of the movement of the tectonic plate. The apparatus is further caused to automatically flag or update the stored position of the map feature based on determining that the estimated position differs from the stored position by more than a distance threshold.

According to another embodiment, an apparatus comprises means for processing data to determine a tectonic plate on which a map feature of a geographic database is located. A stored position of the map feature is associated with a time epoch assigned to the stored position . The apparatus also comprises means for determining a velocity of a movement of the tectonic plate. The apparatus further comprises means for monitoring an estimated position of the map feature over time based on the stored position and the velocity of the movement of the tectonic plate. The apparatus further comprises means for automatically flagging or updating the stored position of the map feature based on determining that the estimated position differs from the stored position by more than a distance threshold.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of maintaining map accuracy considering tectonic plate movements, according to one embodiment;

FIG. 2A is a diagram of an interactive map of ITRF2014 stations, according to one embodiment;

FIG. 2B is a diagram of horizontal velocity fields of the ITRF2014 stations, according to one embodiment;

FIG. 2C is a diagram of a user interface illustrating the example data record of a reference base station, according to one embodiment;

FIGS. 2D-2E are diagrams of an example map feature data record corresponding to two time epochs, according to various embodiments;

FIG. 3 is a diagram of components of a mapping platform capable of maintaining map accuracy, according to one embodiment;

FIG. 4 is a flowchart of a process for maintaining map accuracy, according to one embodiment;

FIGS. 5A-5C are diagrams illustrating example user interfaces for maintaining map accuracy and updating map features, according to various embodiments;

FIG. 6 is a diagram of a geographic database, according to one embodiment;

FIG. 7 is a diagram of hardware that can be used to implement an embodiment;

FIG. 8 is a diagram of a chip set that can be used to implement an embodiment; and

FIG. 9 is a diagram of a mobile terminal (e.g., handset) that can be used to implement an embodiment.

### DESCRIPTION OF SOME EMBODIMENTS

Examples of a method, apparatus, and computer program for maintaining map accuracy considering tectonic plate movements are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

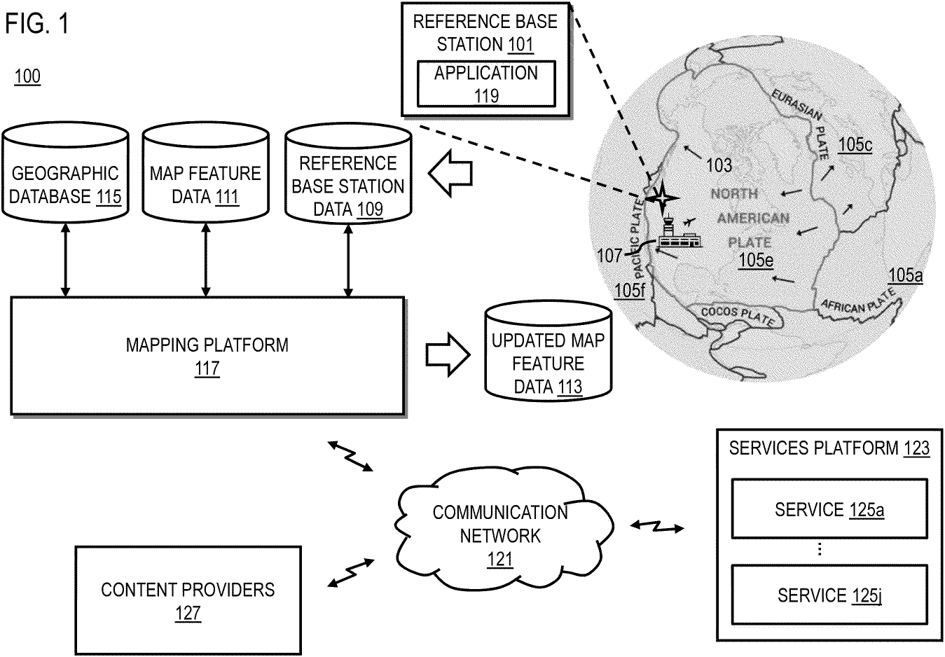

FIG. 1 is a diagram of a system capable of maintaining map accuracy considering tectonic plate movements, according to one embodiment. There are hundreds of reference base stations 101 that precisely monitor the velocities 103 of over twenty tectonic plates 105 moving above the molten mantle below them thereby supporting a reference frame that is a global coordinate system used for measuring position at a particular epoch (i.e., the time at which a known position is record or a time window for estimating the current position of a map feature 107). Tectonic plates 105 are defined as major and minor plates depending on their size. The major tectonic plates (e.g., the African Plate 105a, the Antarctic Plate 105b, the Eurasian Plate 105c, the Indo-Australian Plate 105d, the North American Plate 105e, the Pacific Plate 105f, and the South American Plate 105g) covering nearly 95% of the Earth’s surface. By way of example, the North American plate 105e contains the continent of North America, a part of the Atlantic Ocean, Greenland, Cuba, and the Bahamas, and shifts roughly southwest 2.3 centimeters (~1 inch) per year. Meanwhile, the Pacific Plate 105f is moving to the northwest at a speed of 7-11 centimeters (~3-4 inches) a year.

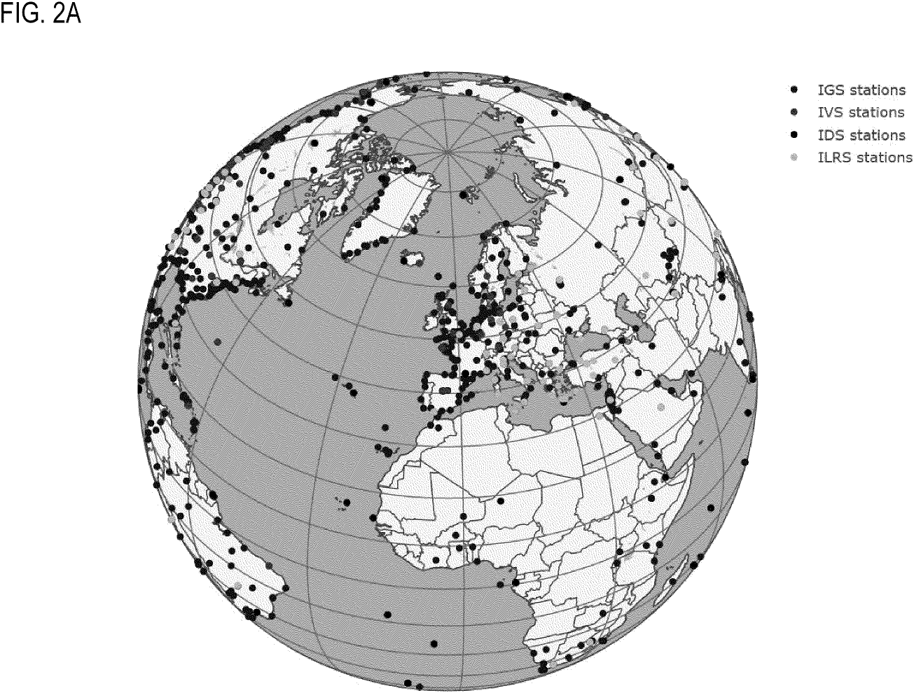

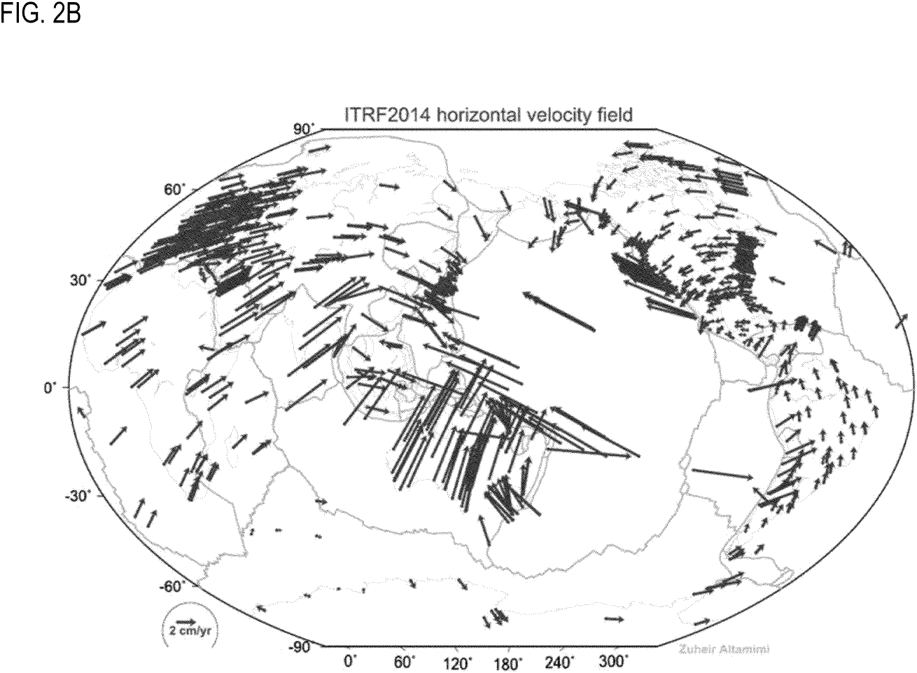

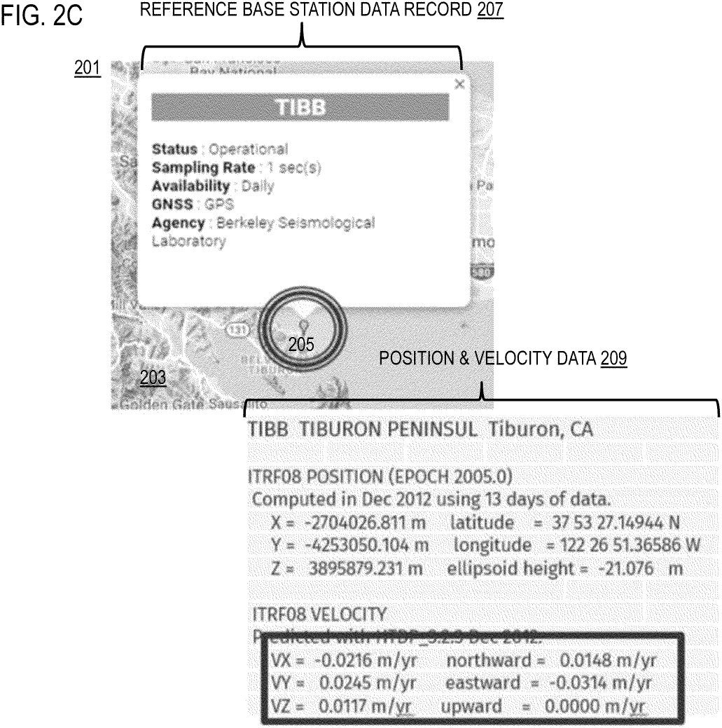

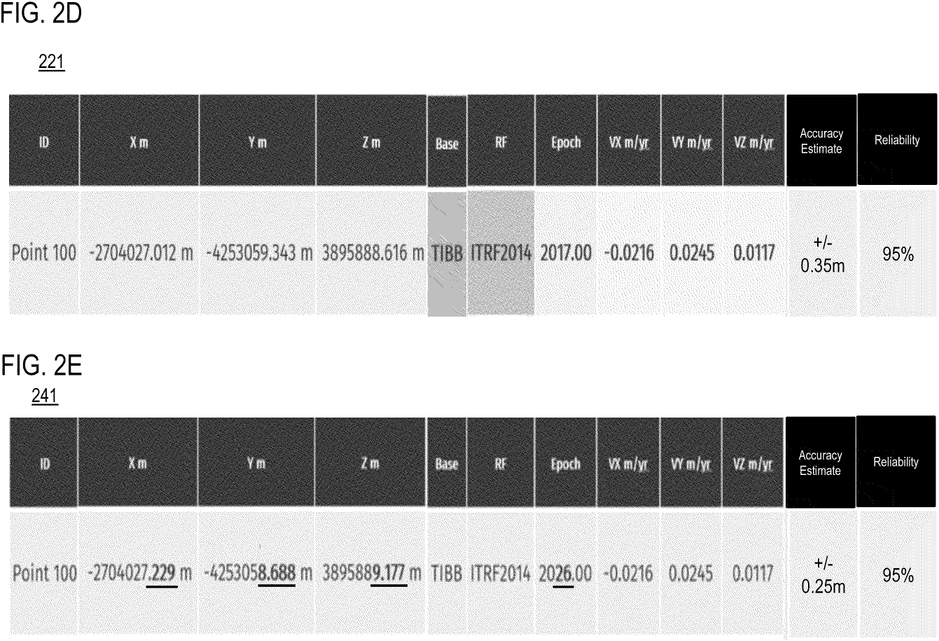

For instance, the reference base stations 101 can provide the basis for the calculation of the linear velocities of the International Terrestrial Reference Frame (ITRF). The ITRF provides an accurate and consistent frame for referencing positions at different times/epochs and in different locations around the world. FIG. 2A is a diagram of an interactive map of ITRF2014 stations, according to one embodiment. An epoch is a moment in time. By way of example, ITRF2014 epoch 2017.0. means the features in the map are where they were at midnight Jan. 1, 2017 (not where they are today).

The ITRF2014, i.e., a set of coordinates and velocities of a network of reference base stations, is generated with a modeling of nonlinear station motions, including seasonal (annual and semiannual) signals of station positions and post-seismic deformation for sites that were subject to major earthquakes. The ITRF2014 uses the full observation history of the stations of four space geodetic techniques including very long baseline interferometry (VLBI), satellite laser ranging (SLR), Global Navigation Satellite Systems (GNSS), and Doppler orbitography and radio positioning integrated by satellite (DORIS), to provide reprocessed time series (weekly from SLR and DORIS, daily from GNSS, and 24 h session-wise from VLBI) of station positions and daily Earth Orientation Parameters. FIG. 2B is a diagram of horizontal velocity fields of the ITRF2014 stations, according to one embodiment. The velocity information is publicly available.

ITRF2014 is a reference frame and epoch, which inevitably drift away from the real world positions by tectonic plate shift, thus requiring accuracy maintenance at a global scale as time passes.

To address these technical challenges, various embodiments of the system 100 described herein introduce a capability to maintain map accuracy (e.g., digital map data of a geographic database). In one embodiment, the system 100 can flag or update a map feature which coordinates expressed in ITRF2014 into a new set of position coordinates when determining that the new position differs from the coordinates expressed in ITRF2014 by more than a distance threshold, e.g., due to tectonic plate drift.

In one embodiment, for a map feature 107 (e.g., a stop sign, a building, an airport, etc.) associated with a reference base station (e.g., TIBB), the system 100 can fuse reference base station velocities 109 of TIBB (e.g., FIG. 2C) into map feature data 111 of the map feature 107 (e.g., FIG. 2D), thereby automatically updating the map feature data 111 associated with a first time epoch into updated map feature data 113 the map feature 107 (e.g., FIG. 2E) associated with a subsequent time epoch considering tectonic plate drift.

FIG. 2C is a diagram of a user interface illustrating the example data record of a reference base station, according to one embodiment. In the example of FIG. 2C, a user interface 201 includes a map 203 marked with a position 205 of a reference base station TIBB located in Tiburon, California. Upon user interaction with a circle around the position 205, the system 100 can surface a reference base station data record 207 over the map 203. For instance, the data record 207 includes Status: Operational, Sampling Rate: 1 sec(s), Availability: Daily, GNSS: GPS, Agency: Berkeley Seismological Laboratory. Upon user interaction with the data record 207, the system 100 can display position and velocity data 209 of the reference base station TIBB in another window. For instance, the position of the base station position at Epoch 2005.0 can be expressed in earth-centered, earth-fixed (ECEF) Cartesian coordinates (e.g., x, y, z) and in a spherical coordinate system using latitude, longitude, and elevation. For areas outside of the United States, the system 100 can use the velocity data from International Terrestrial Reference System base stations (e.g., TIBB). Within the United States, the system 100 can also use HTDP (Horizontal Time-Dependent Positioning) Software Version 3.2.3 to predict the respective velocities of December 2012 expressed in Vx, Vy, Vz, and/or in northward, eastward, upward. HTDP also supports transforming positional coordinates across time and between spatial reference frames, estimating crustal displacements between two specified dates, transforming crustal velocities from one reference frame to another, etc.

With the position data of the reference base station TIBB (e.g., x, y, z) in FIG. 2C, the system 100 can determine that TIBB is the closest reference base station to the map feature 107. In addition, the system 100 can fuse the velocity data of the reference base station TIBB (e.g., Vx, Vy, Vz) in FIG. 2C into map feature data of the map feature 107, in order to provide the map feature record 111 for later processing.

According to FIG. 2C, the base station TIBB is moving at 0.0148N and -0.0314E in meters per year. Consequentially, the map feature 107 (e.g., a stop sign, a building, etc.) has coordinates with an accuracy of +/-0.35 m in a standard reference frame and epoch can be outside of its expected +/-1 m accuracy in five years from 2014.0. To maintain the accuracy of the map feature 107, the system 100 can differentially correct/update the position of the map feature 107 in a geographic database 115 based on velocity data of the relevant reference base station (e.g., TIBB) as follows.

By way of example, the system 100 can fuse the velocity data of the reference base station TIBB (e.g., Vx, Vy, Vz) associated with Epoch (e.g., 2017.00) into map feature data the map feature 107 as an example map feature record shown in FIG. 2D. In FIG. 2D, the system 100 generates a map feature record 221 including: Record ID (e.g., Point 100 of the map feature 107), Position (e.g., Xm, Ym, Zm), Name (e.g., of an associated base station TIBB), Reference frame (e.g., ITRF2014), Epoch (e.g., 2017.00), Velocities of TIBB (e.g., Vx, Vy, Vz), Accuracy Estimate (e.g., +/- 0.35 m), and Reliability of the Estimate (e.g., 95%).

In one embodiment, the system 100 can monitor the accuracy and reliability of the map feature position based on the base station velocities. For instance, the system 100 can apply a constant automatic watcher (e.g., residing in a mapping platform 117, an application 119 of the base station 101, the cloud, an application of a vehicle and/or a user equipment (UE) device, etc.) based on the base station velocities (e.g., Vx, Vy, Vz) to throw a flag when the map feature record 221 is about to go out of the accuracy threshold (e.g., +/-1 m @95%). Such flag can trigger an alert to a map service provider and/or invoke an automatic routine to update the map feature position associated with the time epoch 2017.00 to another time epoch (e.g., 2026.00) for example, into the map feature record 241 in FIG. 2E, to satisfy the accuracy threshold. By way of example, the position of the map feature 107 into (Xm = 12704027.012 m, Ym = -4253059.343 m, Zm = 3895888.616 m) in FIG. 2D can be updated into (Xm = 12704027.229 m, Ym = -4253058.688 m, Zm = 3895889.177 m) in FIG. 2E. This strategy ensures that every single map feature in the geographic database 115 can be automatically updated within 1 meter of its actual position in the real world from a known epoch and then after (e.g., to position within 1 meter to start with). The system 100 does not require every map feature to stay in the same epoch, to maintain absolute accuracy first and foremost.

The constant automatic watcher can reside in a mapping platform 117, an application 119 of the base station 101, the cloud, an application of a vehicle and/or a user equipment (UE) device, etc.

A map feature can represent a physical feature on the ground (e.g., a traffic sign, a road, a building, an airport, etc.) using tags attached to its basic data structures (its nodes, ways, and relations). Each tag describes a geographic attribute of the map feature being shown by that specific node, way or relation. By way of example, in OpenStreetMap, a feature is a physical element in the landscape that can be mapped. This can include both natural and manmade objects in the real world. OpenStreetMap allows an unlimited number of attributes describing a feature, and uses the feature pages to provide short descriptions of tags that relate to particular features.

One of the unique aspects of the system 100 is to automatically monitor and detect when the accuracy of a stored map feature in a map database is about to go out of a specification (e.g., >1 meter accuracy) and update or flag the map data record. Therefore, the system 100 can automatically keep the accuracy of the geographic database despite shifting tectonic plates.

Leveraging the velocity data of the reference base station data 109 (e.g.. the data shown in FIG. 2C) to flag/update the position data of a map feature will enable the system 100 to maintain a required map accuracy not only in the direct vicinity of a road where the most stringent accuracy requirements need to be (e.g., for certain applications such as autonomous driving, navigation, etc.) but also around the world. This will maintain the accuracy of all map features and attributes such as localization objects (e.g., signs, poles, etc.), bridges, overpasses, underpasses, and/or equivalent map features of the geographic database 115.

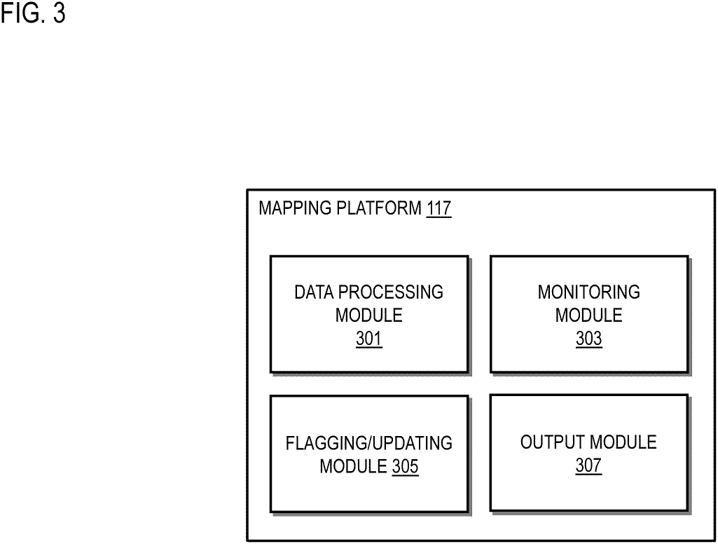

In one embodiment, the system 100 includes the mapping platform 117 for performing one or more functions associated with maintaining map accuracy considering tectonic plate movements. FIG. 3 is a diagram of example components of the mapping platform 117, according to one embodiment. As shown, the mapping platform 117 includes a data processing module 301, a monitoring module 303, a flagging/updating module 305, and an output module 307. The above presented modules and components of the mapping platform 117 can be implemented in hardware, firmware, software, or a combination thereof. Though depicted as a separate entity in FIG. 1, it is contemplated that the mapping platform 117 may be implemented as a module of any of the components of the system 100 (e.g., a component of the services platform 123, services 125, content providers 127, UEs, vehicles, and/or the like). It is also contemplated that the functions of the components of the mapping platform 117 may be combined or performed by other components of equivalent functionality. In another embodiment, one or more of the modules 301 -307 may be implemented as a cloud-based service, local service, native application, or combination thereof. The functions of the mapping platform 117 and modules 301-307 are discussed with respect to the figures below.

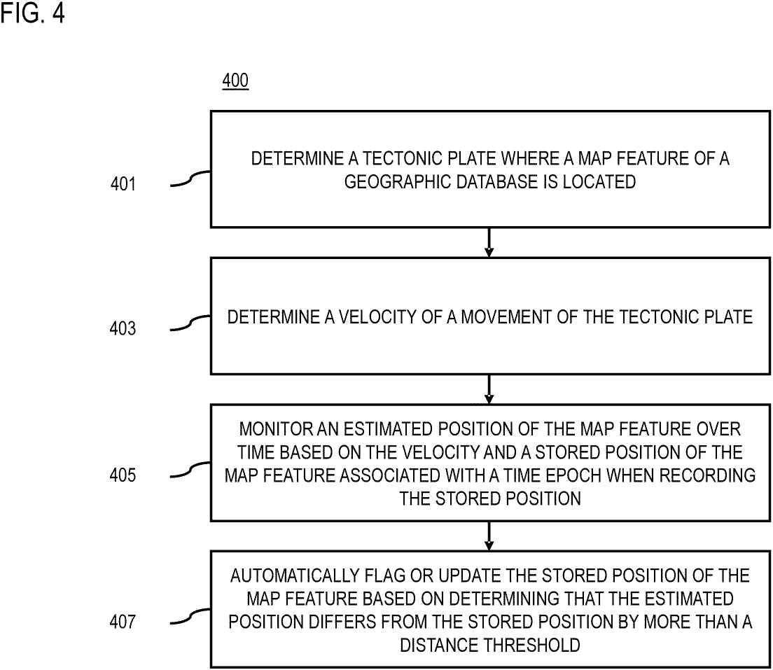

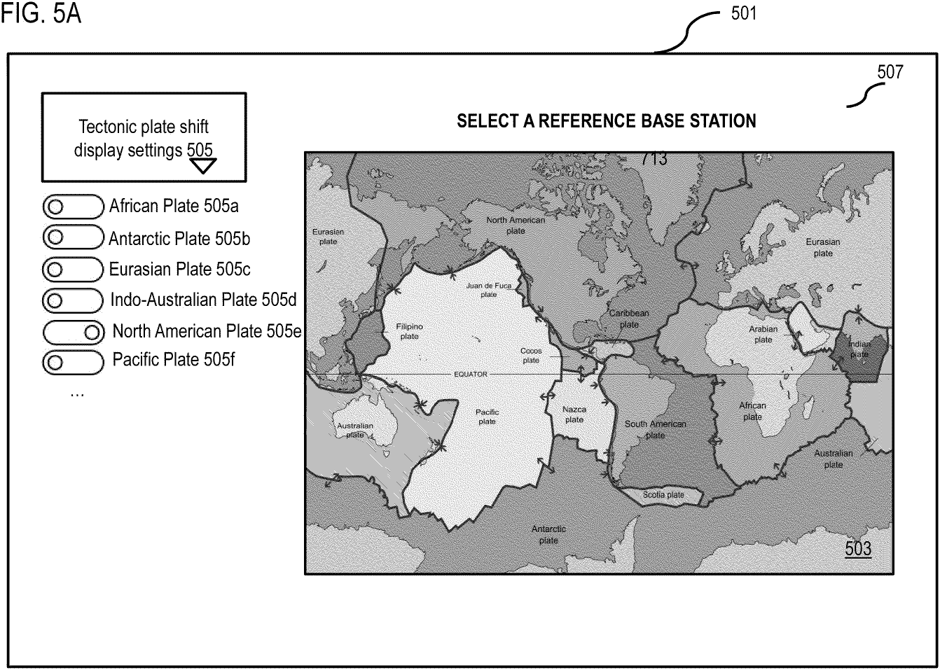

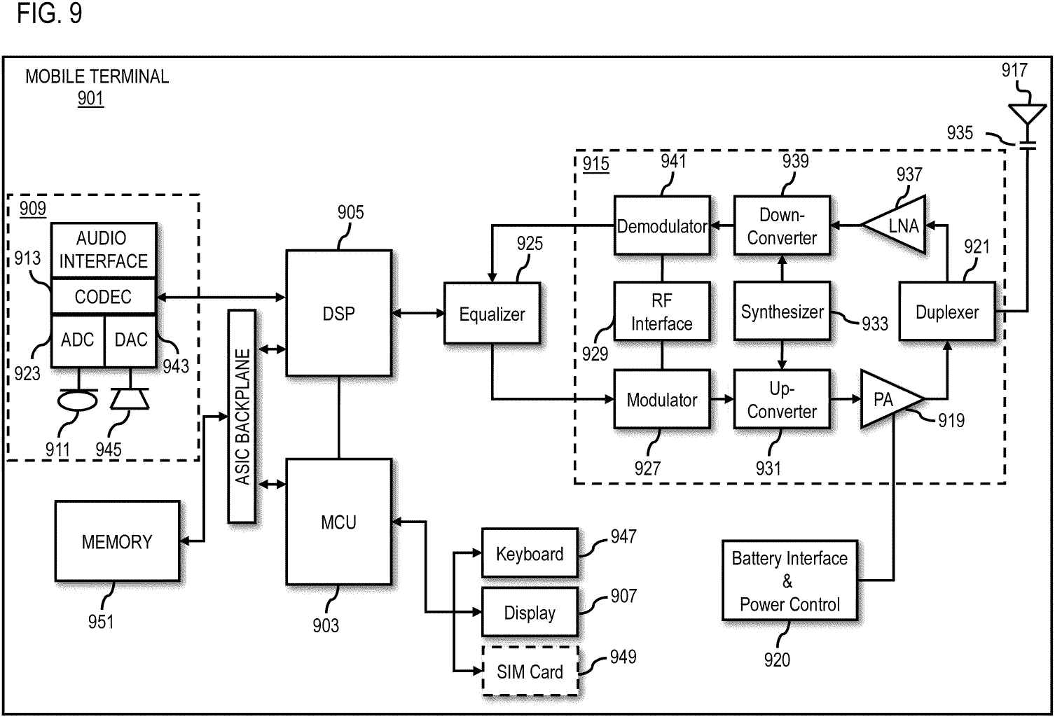

FIG. 4 is a flowchart of a process for maintaining map accuracy considering tectonic plate movements, according to one embodiment. In various embodiments, the mapping platform 117 and/or any of the modules 301-307 may perform one or more portions of the process 400 and may be implemented in, for instance, a chip set including a processor and a memory as shown in FIG. 9. As such, the mapping platform 117 and/or any of the modules 301-307 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In one embodiment, for example, in step 401, the data processing module 301 can process data (e.g., velocity data from sources such as the International Terrestrial Reference Frame https://itrf.ign.fr/site info and select/site.php?domesnum=10002S002) to determine a tectonic plate on which a map feature of a geographic database is located. A stored position of the map feature is associated with a time epoch assigned to the stored position. For instance, the stored position data was collected using at least one sensor of at least one probe device traveling in the geographic area. For example, the position data values are position sensor readings indicating, for instance, a location (e.g., latitude and longitude) and elevation of the probe device at a point in time. In one embodiment, the probe device can be configured to sense (e.g., via a positioning or location sensor - such as a GNSS receiver or equivalent) and record its location at can be specified frequency (e.g., once every 1 s, 2 s, 10 s, etc.). When the stored position data arranged in chronological order according to position sampling time, a trajectory of the probe device through the geographic area.

The geographic database can be an open-source database, a commercial database, and/or any other existing off-the-shelf map feature source. In addition or alternatively, the map feature sources can include databases that are proprietary to a respective services, etc. generated using any means (e.g., remote sensing as well as non-remote sensing like direct surveying, etc.). In some cases, the map feature source is generated based on sensor data (e.g., imagery) collected using one or more aerial devices (e.g., airplanes, aerial drones, etc.), satellite devices, and/or any other remote sensing device capable of generating sensor data or imagery from an overhead perspective.

In one embodiment, the map feature is stored in the geographic database as a data record comprising at least one of: (1) a map feature identifier field; (2) one or more map feature position fields; (3) a reference base station field; (4) a time epoch field; (5) one or more fields indicating the velocity of the movement of the tectonic plate, (6) a position accuracy estimate; and (7) reliability of the position accuracy estimate.

In one embodiment, in step 403, the data processing module 301 can determine a velocity of a movement of the tectonic plate. In one embodiment, the velocity of the movement of the tectonic plate is determined with respect to a reference frame. For instance, the reference frame is an International Terrestrial Reference Frame (ITRF).

In one embodiment, the stored position data (e.g., of the map feature data 111) can be differentially updated to improve accuracy of the location and elevation of corresponding map feature (e.g., a stop sign) to a target level of accuracy (e.g., to meter-level accuracy or better), for example, using the velocity data of reference base stations located at known locations as determined based in ITRF. For instance, the data processing module 301 can determine a reference base station located on the tectonic plate, and the velocity of the movement of the tectonic plate can be determined with respect to the reference base station. By way of example, the reference base station is determined based a distance (e.g., the shortest distance) of the reference base station to the stored position of the map feature.

In one embodiment, in step 405, the monitoring module 303 can monitor an estimated position of the map feature over time based on the stored position and the velocity of the movement of the tectonic plate. In one embodiment, the velocity of the movement of the tectonic plate can include one or more earth-centered earth-fixed Cartesian coordinates velocities (e.g., Vx, Vy, and Vz). In another embodiment, the velocity of the movement of the tectonic plate can include a north/south velocity, an east/west velocity, an up/down velocity, or a combination thereof.

In one embodiment, in step 407, the flagging/updating module 305 can automatically flag or update the stored position of the map feature based on determining that the estimated position differs from the stored position by more than a distance threshold. Since all positions of map features have an estimated error (e.g., +/-0.35 m) and the estimated error has a probability (or reliability (e.g., 95%), the system 100 can consider both factors in calculating when the position of the map feature will drift away from the stored position by a distance threshold.

For instance, the flagging occurs before the estimated position differs from the stored position by more than the distance threshold. As another instance, the flagging/updating module 305 can automatically update the stored position by replacing the stored position in the geographic database with the estimated position, and updating the time epoch associated with the stored position to a new time epoch at which the estimated position is determined to differ from the stored position by more than the distance threshold.

In one embodiment, the system 100 can validate the updated position with data collected by ground surveyors who go out in the field and use instruments like a theodolite, measuring tape, three-dimensional (3D) scanner, satellite-based location sensors (e.g., GPS/GNSS), level and rod, etc. to measure the locations of ground control points with respect to the locations of map features (e.g. signs, barriers, buildings, etc.).

In one embodiment, the output module 307 can provide a representation of the flagging, the updating, or a combination thereof in a user interface of a device. By way of example, the representation of the flagging/updating is provided to a UE of a map service provider. As another example, the representation of the flagging/updating is provided to an autonomous driving system of a vehicle. As yet another example, the representation of the flagging/updating is used to generate a mapping user interface, a navigation user interface, or a combination thereof for a vehicle user (e.g., an operator, a passenger, etc.).

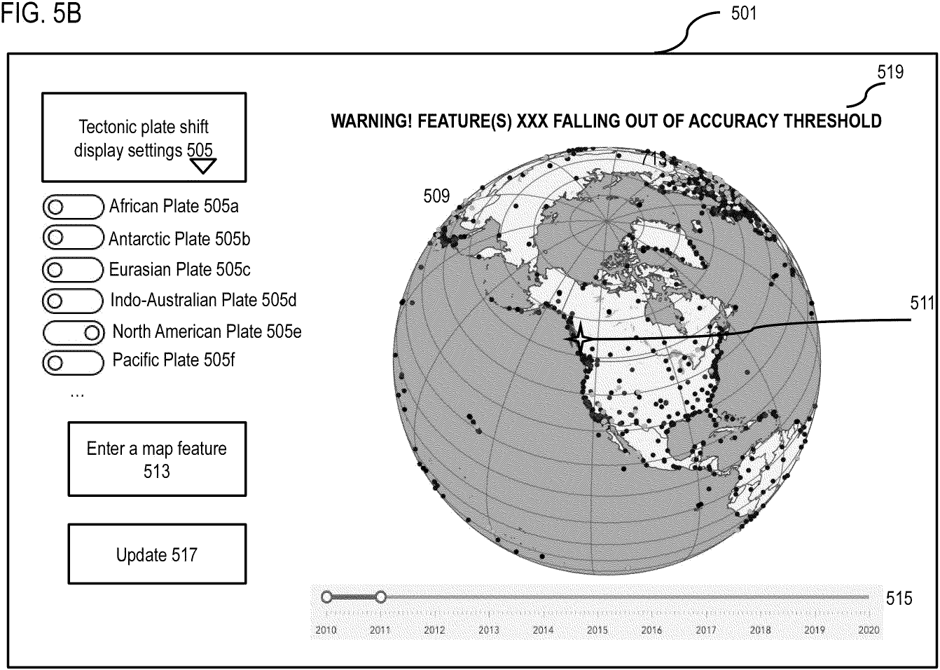

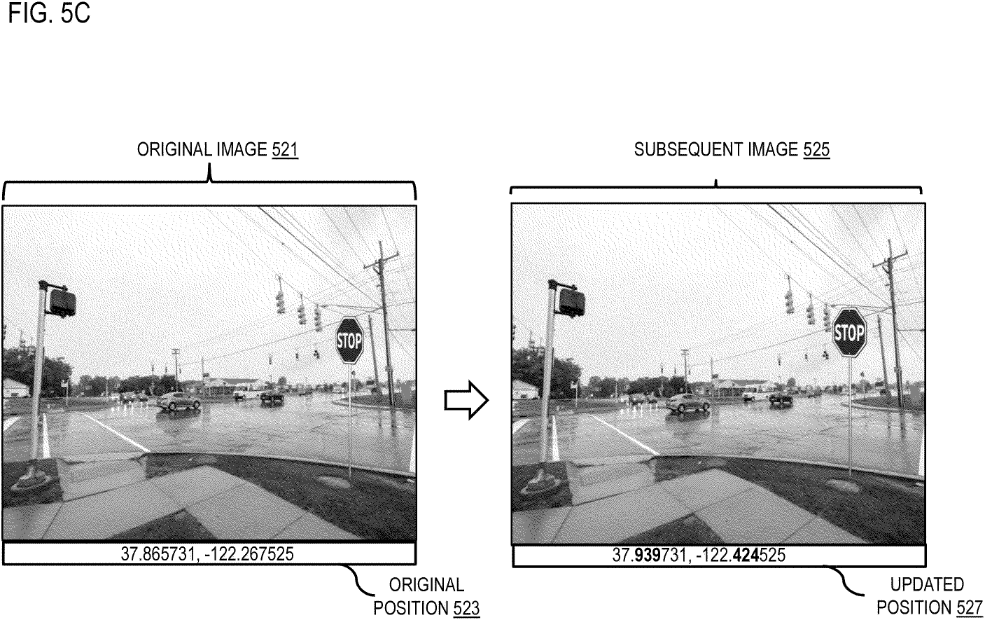

FIGS. 5A-5C are diagrams illustrating example user interfaces for maintaining map accuracy and updating map features, according to various embodiments. Referring to FIG. 5A, in one embodiment, the system 100 can generate a user interface (UI) 501 (e.g., the application 119) for a reference base station staff, a map service provider server, a vehicle, a UE, etc. that can allow a user to see velocities associated with tectonic plate movements and/or base stations currently and/or over time (e.g., an hour, a day, a week, a month, a year, etc.) in a geographic area (e.g., a community, a city, a country, a region, the world, etc.), map data before and after an update to another time epoch on a map 503 upon selection of one or more tectonic plates, one or more reference base stations, one or more map features, etc. For instance, the tectonic plate shift display settings 505 in FIG. 5A includes options of the African Plate 505a, the Antarctic Plate 505b, the Eurasian Plate 505c, the Indo-Australian Plate 505d, the North American Plate 505e, the Pacific Plate 505f, etc. In FIG. 5A, for example, in response to a user selection of the North American Plate 505e, and the system 100 can determine and present the reference base stations associated with the North American Plate 505e at the epoch 2010.00. The system 100 can then display a map 507 focusing on North American Plate 505e and an alert 509: “Select a reference base station.”

Upon another user selection of a reference base station 511 (e.g., TIBB) in the map 507 in FIG. 5B, the system 100 further display a map feature field 513 and a timeline 515. When the user enters a map feature (e.g., a stop sign) in the map feature field 513, and slides a marker on the timeline 515 to the epoch 2011.00, the system 100 can update map data associated with the reference base station 511 based on the velocities associated with the reference base station 511 to the epoch 2011.00. When the user selects a “update” option 517, the system 100 can update the position of the map feature in a map database (e.g., the geographic database 115) to the epoch 2011.00 accordingly.

FIG. 5C is a diagram of an example map feature updated based on tectonic plate movement velocities associated with a corresponding base station, according to one embodiment. As shown, an original image 521 is selected for a map feature (e.g., a stop sign) according to the embodiments described herein. In the original image 521, the stop sign is mapped to an original position 523 (e.g., 37.865731, -122.267525) associated with epoch 2010.00. Upon the user selection of epoch 2011.00, the system 100 updates the original position 523 into an updated position 527 (e.g., 37.939731, -122.424525) in a subsequent image 525 using velocities associated with a corresponding base station (e.g., TIBB). In one embodiment, in addition to or in place of the horizontal alignment described above, the system 100 can update the vertical or elevation of the corresponding map feature.

Concurrently or alternatively, the system 100 can monitor all map features in the map database, and flag one or more alerts of that one or more map features are about to go out of an accuracy threshold (e.g., +/-1m @95%). By way of example, in FIG. 5B, the system 100 displays an alert 519: "Warning! Feature(s) XXX falling out of an accuracy threshold." In this case, the system 100 can prompt the user to select the option “Update” 517, or automatically update the map feature(s) as discussed.

By way of example, the updated map feature(s) can be transmitted (e.g., over a communication network 121) to any service and/or application requesting high accuracy map data (e.g., a services platform 123 comprising one or more services 125a-125j - also collectively referred to services 125). Examples of these services 125 include but are not limited to mapping services, navigation services, autonomous driving, environmental modeling, etc.

For example, in one embodiment, the updated map feature(s) is used to generate a mapping user interface, a navigation user interface, or a combination thereof based on the output. Then, output module 307 presents the mapping user interface, the navigation user interface, or a combination thereof on an output device (e.g., a navigation device of a vehicle or UE device executing a location-based application). The resulting mapping and/or navigation user interface will then be able to represent the terrain or topography of a geographic at higher accuracy (e.g., greater than 1 meter accuracy).

In another embodiment, the updated map feature(s) is provided to an autonomous driving system of a vehicle. For example, autonomous driving is becoming a reality following advances in machine learning, computer vision, and compute power. The ability to perceive the world with an accurate semantic understanding enables vehicles (e.g., an autonomous vehicle) to obey driving rules and avoid collisions. As these perceptual abilities have improved, so has the need for highly accurate and up-to-date maps. Path planning, for instance, requires knowledge of what to expect beyond a vehicle’s perceptual horizon, and driving in complicated terrains and environments with many occluding objects requires a knowledge of what may not be detectable by onboard sensors.

Returning to FIG. 1, as shown, the system 100 includes the mapping platform 117 for maintaining map accuracy considering tectonic plate movements according to the various embodiments described herein. The mapping platform 117 also has connectivity or access to the geographic database 115 which stores digital map data for use in generating or otherwise using updated map feature data 113. In one embodiment, the geographic database 115 includes representations of mapped ground control points and related geographic features to maintain map accuracy. As shown, the mapping platform 117 has connectivity over the communication network 121 to the services platform 123 that provides one or more services 125 that can use or provide data for maintaining map accuracy. By way of example, the services 125 may be third party services and include mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 125 uses the output of the mapping platform 117 to provide services 125 such as navigation, mapping, other location-based services, etc.

In one embodiment, the mapping platform 117 may be a platform with multiple interconnected components. The mapping platform 117 may include multiple servers, intelligent networking devices, computing devices, components, and corresponding software for maintaining map accuracy. In addition, it is noted that the mapping platform 117 may be a separate entity of the system 100, a part of the one or more services 125, a part of the services platform 123, or included within the UE and/or vehicle. In one embodiment, content providers 127 (collectively referred to as content providers 127) may provide content or data (e.g., including reference base station data 109, map feature data 111, updated map feature data 113, etc.) for use according to the various embodiments described herein.

In one embodiment, the UE and/or vehicle may execute a software application to capture sensor data for generating the map feature data 111. By way of example, the application may also be any type of application that is executable on the UE and/or vehicle, such as autonomous driving applications, mapping applications, location-based service applications, navigation applications, content provisioning services, camera/imaging application, media player applications, social networking applications, calendar applications, and the like. In one embodiment, the application may act as a client for the mapping platform 117 and perform one or more functions associated with maintaining map accuracy considering tectonic plate movements alone or in combination with the mapping platform 117.

By way of example, the UE is any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE can support any type of interface to the user (such as “wearable” circuitry, etc.). In one embodiment, the UE may be associated with the vehicle or be a component part of the vehicle.

In one embodiment, the UE and/or vehicle are configured with various sensors for generating or collecting sensor data (e.g., for processing by the mapping platform 117), related geographic data, etc. In one embodiment, the sensed data represent sensor data associated with a geographic location or coordinates at which the sensor data was collected. By way of example, the sensors may include a global positioning sensor for gathering location data (e.g., GNSS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture ground control point imagery, etc. for analysis), an audio recorder for gathering audio data, velocity sensors mounted on steering wheels of the vehicles, switch sensors for determining whether one or more vehicle switches are engaged, and the like.

Other examples of sensors of the UE and/or vehicle may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the UE and/or vehicle may detect the relative distance of the vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the UE and/or vehicle may include GPS or other satellite-based receivers to obtain geographic coordinates for determining current location and time. Further, the location can be determined by visual odometry, triangulation systems such as A-GPS, Cell of Origin, or other location extrapolation technologies. In yet another embodiment, the sensors can determine the status of various control elements of the car, such as activation of wipers, use of a brake pedal, use of an acceleration pedal, angle of the steering wheel, activation of hazard lights, activation of head lights, etc.

In one embodiment, the communication network 121 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 117, services platform 123, services 125, UE, vehicle, and/or content providers 127 communicate with each other and other components of the system 100 using well known, new or still developing protocols. In this context, a protocol includes a set of rules defining how the network nodes within the communication network 121 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

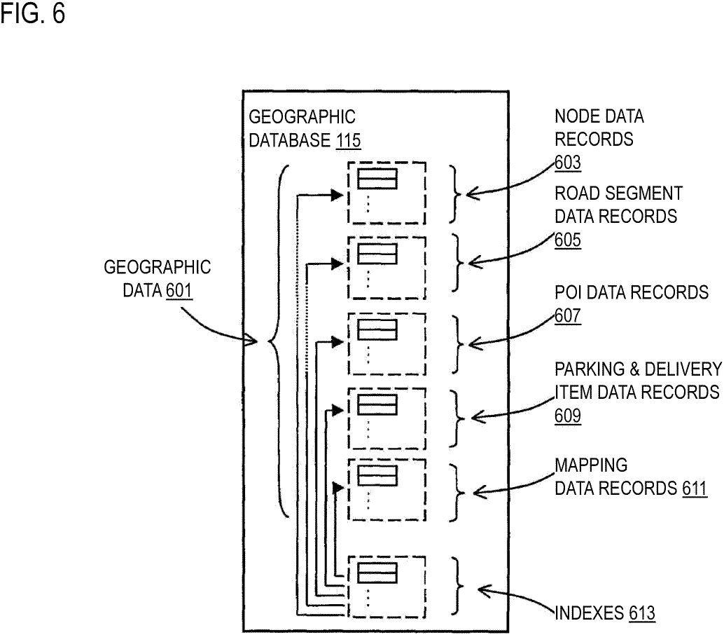

FIG. 6 is a diagram of a geographic database (such as the database 115), according to one embodiment. In one embodiment, the geographic database 115 includes geographic data 601 used for (or configured to be compiled to be used for) mapping and/or navigation-related services, such as for video odometry based on the parametric representation of lanes include, e.g., encoding and/or decoding parametric representations into lane lines. In one embodiment, the geographic database 115 include high resolution or high definition (HD) mapping data that provide centimeter-level or better accuracy of map features. For example, the geographic database 115 can be based on Light Detection and Ranging (LiDAR) or equivalent technology to collect very large numbers of 3D points depending on the context (e.g., a single street/scene, a country, etc.) and model road surfaces and other map features down to the number lanes and their widths. In one embodiment, the mapping data (e.g., mapping data records 611) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 115.

“Node” - A point that terminates a link.

“Line segment” - A straight line connecting two points.

“Link” (or “edge”) - A contiguous, non-branching string of one or more line segments terminating in a node at each end.

“Shape point” - A point along a link between two nodes (e.g., used to alter a shape of the link without defining new nodes).

“Oriented link” - A link that has a starting node (referred to as the “reference node”) and an ending node (referred to as the “non reference node”).

“Simple polygon” - An interior area of an outer boundary formed by a string of oriented links that begins and ends in one node. In one embodiment, a simple polygon does not cross itself.

“Polygon” - An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 115 follows certain conventions. For example, links do not cross themselves and do not cross each other except at a node. Also, there are no duplicated shape points, nodes, or links. Two links that connect each other have a common node. In the geographic database 115, overlapping geographic features are represented by overlapping polygons. When polygons overlap, the boundary of one polygon crosses the boundary of the other polygon. In the geographic database 115, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 115 includes node data records 603, road segment or link data records 605, POI data records 607, reference base station data records 609, mapping data records 611, and indexes 613, for example. More, fewer or different data records can be provided. In one embodiment, additional data records (not shown) can include cartographic (“carto”) data records, routing data, and maneuver data. In one embodiment, the indexes 613 may improve the speed of data retrieval operations in the geographic database 115. In one embodiment, the indexes 613 may be used to quickly locate data without having to search every row in the geographic database 115 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points (such as intersections) corresponding to the respective links or segments of the road segment data records 605. The road link data records 605 and the node data records 603 represent a road network, such as used by vehicles, cars, and/or other entities. Alternatively, the geographic database 115 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 115 can include data about the POIs and their respective locations in the POI data records 607. The geographic database 115 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city). In one embodiment, certain attributes, such as lane marking data records, mapping data records and/or other attributes can be features or layers associated with the link-node structure of the database.

In one embodiment, the geographic database 115 can also include reference base station data records 609 for base station location data and the respective velocity data, storing training data, prediction models, annotated observations, computed featured distributions, sampling probabilities, and/or any other data generated or used by the system 100 according to the various embodiments described herein. By way of example, the reference base station data records 609 can be associated with one or more of the node records 603, road segment records 605, and/or POI data records 607 to support localization or visual odometry based on the features stored therein and the corresponding estimated quality of the features. In this way, the records 609 can also be associated with or used to classify the characteristics or metadata of the corresponding records 603, 605, and/or 607.

In one embodiment, as discussed above, the mapping data records 611 model road surfaces and other map features to centimeter-level or better accuracy. The mapping data records 611 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 611 are divided into spatial partitions of varying sizes to provide mapping data to vehicles and other end user devices with near real-time speed without overloading the available resources of the vehicles and/or devices (e.g., computational, memory, bandwidth, etc. resources).

In one embodiment, the mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 611.

In one embodiment, the mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 115 can be maintained by the content provider 127 in association with the services platform 117 (e.g., a map developer). The map developer can collect geographic data to generate and enhance the geographic database 115. There can be different ways used by the map developer to collect data. These ways can include obtaining data from other sources, such as municipalities or respective geographic authorities. In addition, the map developer can employ field personnel to travel by vehicle (e.g., vehicles and/or UEs) along roads throughout the geographic region to observe features and/or record information about them, for example. Also, remote sensing, such as aerial or satellite photography, can be used.

The geographic database 115 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle or a UE, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for maintaining map accuracy considering tectonic plate movements may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

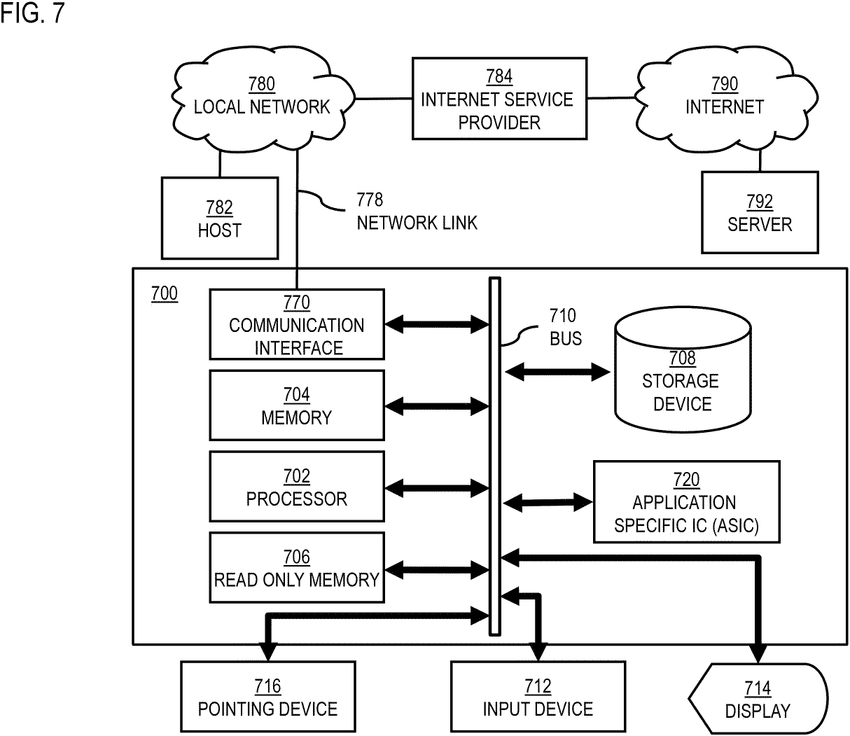

FIG. 7 illustrates a computer system 700 upon which an embodiment of the invention may be implemented. Computer system 700 is programmed (e.g., via computer program code or instructions) to maintain map accuracy considering tectonic plate movements as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to maintaining map accuracy considering tectonic plate movements. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for maintaining map accuracy considering tectonic plate movements. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for maintaining map accuracy considering tectonic plate movements, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 121 for maintaining map accuracy considering tectonic plate movements to the map feature data in the geographic database 115.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

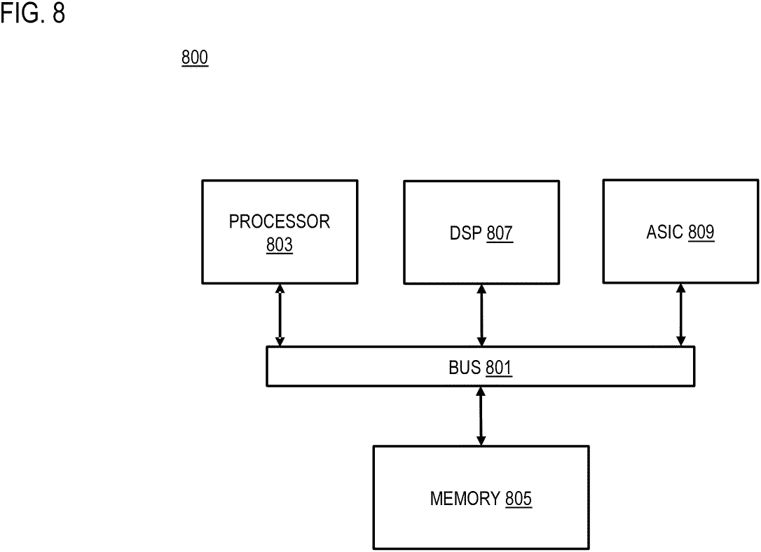

FIG. 8 illustrates a chip set 800 upon which an embodiment of the invention may be implemented. Chip set 800 is programmed to maintain map accuracy considering tectonic plate movements as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to maintain map accuracy considering tectonic plate movements. The memory 805 also stores the data associated with or generated by the execution of the inventive steps.

FIG. 9 is a diagram of exemplary components of a mobile terminal 901 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903–which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to maintain map accuracy considering tectonic plate movements. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
processing data to determine a tectonic plate on which a map feature of a geographic database is located, wherein a stored position of the map feature is associated with a time epoch assigned to the stored position;
determining a velocity of a movement of the tectonic plate;
monitoring an estimated position of the map feature over time based on the stored position and the velocity of the movement of the tectonic plate; and
automatically flagging or updating the stored position of the map feature based on determining that the estimated position differs from the stored position by more than a distance threshold.

2. The method of claim 1, wherein the updating of the stored position comprises:
replacing the stored position in the geographic database with the estimated position; and
updating the time epoch associated with the stored position to a new time epoch at which the estimated position is determined to differ from the stored position by more than the distance threshold.

3. The method of claim 1, further comprising:
determining a reference base station located on the tectonic plate,
wherein the velocity of the movement of the tectonic plate is determined with respect to the reference base station.

4. The method of claim 3, wherein the reference base station is determined based a distance of the reference base station to the stored position of the map feature.

5. The method of claim 1, wherein the velocity of the movement of the tectonic plate includes one or more earth-centered earth-fixed Cartesian coordinates velocities, a north/south velocity, an east/west velocity, an up/down velocity, or a combination thereof.

6. The method of claim 1, wherein the map feature is stored in the geographic database as a data record comprising at least one of:
a map feature identifier field;
one or more map feature position fields;
a reference base station field;
a time epoch field;
one or more fields indicating the velocity of the movement of the tectonic plate;
a position accuracy estimate; and
reliability of the position accuracy estimate.

7. The method of claim 1, wherein the flagging occurs before the estimated position differs from the stored position by more than the distance threshold.

8. The method of claim 1, further comprising:
providing a representation of the flagging, the updating, or a combination thereof in a user interface of a device.

9. The method of claim 1, wherein the velocity of the movement of the tectonic plate is determined with respect to a reference frame.

10. The method of claim 9, wherein the reference frame is an International Terrestrial Reference Frame (ITRF).

11. An apparatus comprising:
at least one processor; and
at least one memory including computer program code for one or more programs,
the at least one memory and the computer program code configured to, with the at least one processor, cause the apparatus to perform at least the following,
process data to determine a tectonic plate on which a map feature of a geographic database is located, wherein a stored position of the map feature is associated with a time epoch assigned to the stored position;
determine a velocity of a movement of the tectonic plate;
monitor an estimated position of the map feature over time based on the stored position and the velocity of the movement of the tectonic plate; and
automatically flag or update the stored position of the map feature based on determining that the estimated position differs from the stored position by more than a distance threshold.

12. The apparatus of claim 11, wherein the updating of the stored position is updated by:
replacing the stored position in the geographic database with the estimated position; and
updating the time epoch associated with the stored position to a new time epoch at which the estimated position is determined to differ from the stored position by more than the distance threshold.

13. The apparatus of claim 11, wherein the apparatus is further caused to:
determine a reference base station located on the tectonic plate,
wherein the velocity of the movement of the tectonic plate is determined with respect to the reference base station.

14. The apparatus of claim 13, wherein the reference base station is determined based a distance of the reference base station to the stored position of the map feature.

15. The apparatus of claim 11, wherein the velocity of the movement of the tectonic plate includes a north/south velocity, an east/west velocity, an up/down velocity, or a combination thereof.

16. The apparatus of claim 11, wherein the map feature is stored in the geographic database as a data record comprising at least one of:
a map feature identifier field;
one or more map feature position fields;
a reference base station field;
a time epoch field;
one or more fields indicating the velocity of the movement of the tectonic plate;
a position accuracy estimate; and
reliability of the position accuracy estimate.

17. A non-transitory computer-readable storage medium carrying one or more sequences of one or more instructions which, when executed by one or more processors, cause an apparatus to perform:
processing data to determine a tectonic plate on which a map feature of a geographic database is located, wherein a stored position of the map feature is associated with a time epoch assigned to the stored position;
determining a velocity of a movement of the tectonic plate;
monitoring an estimated position of the map feature over time based on the stored position and the velocity of the movement of the tectonic plate; and
automatically flagging or updating the stored position of the map feature based on determining that the estimated position differs from the stored position by more than a distance threshold.

18. The non-transitory computer-readable storage medium of claim 17, wherein the updating of the stored position comprises:
replacing the stored position in the geographic database with the estimated position; and
updating the time epoch associated with the stored position to a new time epoch at which the estimated position is determined to differ from the stored position by more than the distance threshold.

19. The non-transitory computer-readable storage medium of claim 17, the apparatus is further caused to perform:
determining a reference base station located on the tectonic plate,
wherein the velocity of the movement of the tectonic plate is determined with respect to the reference base station.

20. The non-transitory computer-readable storage medium of claim 19, wherein the reference base station is determined based a distance of the reference base station to the stored position of the map feature.
